(19) United States
(12) Patent Application Publication
(10) Pub. No.: US 2019/0119490 A1
(43) Pub. Date: Apr. 25, 2019

(54) RESIN COMPOSITION, MOULDED ARTICLE, AND PLATED MOULDED ARTICLE

(71) Applicant: KANEKA CORPORATION, Osaka-shi (JP)

(72) Inventors: Shusuke YOSHIHARA, Settsu-shi (JP); Keika HATTORI, Settsu-shi (JP)

(73) Assignee: KANEKA CORPORATION, Osaka-shi (JP)

(21) Appl. No.: 16/090,718

(22) PCT Filed: Apr. 5, 2017
(86) PCT No.: PCT/JP2017/014201

§ 371 Date: Oct. 2, 2018

(30) Foreign Application Priority Data
Apr. 6, 2016 (JP) 2016-076837

(51) Int. Cl. C08L 69/00

(52) U.S. Cl. CPC C08L 69/00

(57) ABSTRACT

A resin composition in accordance with an embodiment of the present invention includes an engineering resin, a graft copolymer, and a flowability enhancing agent which includes a polyester obtained through polycondensation of bisphenol and dicarboxylic acid and, optionally, biphenol in specific proportions. The resin composition has melt flowability improved without loss of an excellent plating property of the graft copolymer and without loss of an excellent property of the engineering resin.

### TECHNICAL FIELD

The present invention relates to a novel resin composition. The present invention further relates to a molded article and a plated molded article each of which is obtained by molding the novel resin composition.

### BACKGROUND ART

A graft copolymer, such as an ABS resin, is excellent in processability, impact resistance, mechanical property, and chemical resistance, and is therefore in wide use, for example, in the fields of vehicles, household electrical appliances, and construction materials. In recent years, in the field of vehicles, excellent secondary processability, especially, an excellent plating property and an excellent coating property of the ABS resin have been receiving attention, and thus the ABS resin has been used for an exterior, such as a door mirror and a radiator grille, of a motor vehicle.

A resin composition made of an ABS resin and an engineering resin has strength improved as compared with the ABS resin, and retains excellent properties, such as heat resistance and impact resistance, of the engineering resin. Therefore, the resin composition has been often used in the fields of molding materials. However, in recent years, the resin composition has been required to have further enhanced melt flowability so that (i) an injection molded article has a complex shape, (ii) a molded article has a depression or a protrusion, such as a rib or a boss, formed thereon, thin molded article is obtained, or the like.

Patent Literature 1 discloses that a resin composition containing an ABS resin, a polycarbonate resin, and an acrylate/aromatic vinyl/vinyl cyanide copolymer has melt flowability improved without loss of a plating property and impact resistance.

### CITATION LIST

### Patent Literature

[Patent Literature 1]

Japanese Patent Application Publication Tokukai No. 2009-292921 (Publication date: Dec. 17, 2009)

### SUMMARY OF INVENTION

### Technical Problem

However, according to a technique disclosed in Patent Literature 1, the foregoing copolymer is not compatible with the polycarbonate resin. Therefore, there is a problem that it is not possible for the resin composition to maintain impact strength unless the ABS resin is used in a large amount.

An object of the present invention is to provide (i) a resin composition having melt flowability improved without loss of an excellent plating property of a graft copolymer (such as an ABS resin) and without loss of excellent properties (such as heat resistance and impact resistance) of an engineering resin and (ii) a molded article and a plated molded article each obtained by molding such a resin composition.

### Solution to Problem

The inventors of the present invention conducted diligent studies and consequently found that it is possible to provide a resin composition, a molded article, and a plated molded article each of which does not have the foregoing problem, by melting and kneading an engineering resin, a graft copolymer, and a flowability enhancing agent which includes a polyester obtained through polycondensation of a bisphenol component and an aliphatic dicarboxylic acid component and, optionally, a biphenol component in specific proportions. As a result, the inventors of the present invention completed the present invention. Specifically, the present invention encompasses inventions as shown in the following <1> through <8>.

<1> A resin composition including: an engineering resin (I);

a flowability enhancing agent (II); and

a graft copolymer (III),

the graft copolymer (III) being a graft copolymer of a rubber polymer (a-1) and a monomer (a-2) which contains an aromatic vinyl monomer and a vinyl cyanide monomer,

the flowability enhancing agent (II) including a polyester which is a polycondensate of a monomer mixture containing biphenol (A) in a proportion of 0 mol % to 55 mol %, bisphenol (B) in a proportion of 5 mol % to 60 mol %, and dicarboxylic acid (C) in a proportion of 40 mol % to 60 mol %, with respect to 100 mol % of a total amount of the biphenol (A), the bisphenol (B), and the dicarboxylic acid (C),

the biphenol (A) being represented by the following general formula (1):

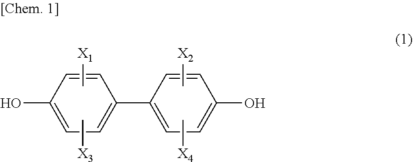

where X₁ through X₄ each independently represent a hydrogen atom, a halogen atom, or an alkyl group having 1 to 4 carbon atom(s) and may be identical to or different from each other,

the bisphenol (B) being represented by the following general formula (2):

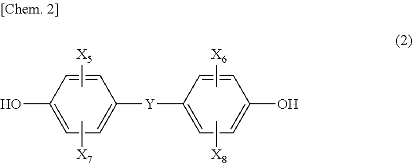

where: X₅ through X₈ each independently represent a hydrogen atom, a halogen atom, or an alkyl group having 1 to 4 carbon atom(s) and may be identical to or different from each other; and Y represents a methylene group, an isopropylidene group, a cyclic alkylidene group, an aryl-substituted alkylidene group, an arylenedialkylidene group, —S—, —O—, a carbonyl group, or —SO₂—, the dicarboxylic acid (C) being represented by the following general formula (3):

HOOC—R₁—COOH (3)

where R₁ represents a divalent linear substituent which has 2 to 18 atoms in its main chain and which may contain a branch.

<2> The resin composition described in <1>, wherein the engineering resin (I) is a polycarbonate resin.

<3> The resin composition described in <1> or <2>, wherein the flowability enhancing agent (II) has a number average molecular weight of 2000 to 30000.

<4> The resin composition described in any one of <1> through <3>, wherein R₁ in the general formula (3) is a linear saturated aliphatic hydrocarbon chain.

<5> The resin composition described in any one of <1> through <4>, wherein: part of terminals of the flowability enhancing agent (II) are each sealed with a monofunctional low molecular weight compound; and a rate of the part of the terminals of the flowability enhancing agent (II), which part are each sealed with the monofunctional low molecular weight compound, is not less than 60%.

<6> The resin composition described in any one of <1> through <5>, wherein the resin composition includes the engineering resin (I) in a proportion of 40% by mass to 90% by mass, the flowability enhancing agent (II) in a proportion of 1% by mass to 20% by mass, and the graft copolymer (III) in a proportion of 10% by mass to 60% by mass, with respect to 100% by mass of the total amount of the engineering resin (I), the flowability enhancing agent (II), and the graft copolymer (III).

<7> A molded article obtained by molding a resin composition described in any one of <1> through <6>.

<8> A plated molded product obtained by plating a molded article described in <7>.

### Advantageous Effects of Invention

A resin composition in accordance with an aspect of the present invention has melt flowability improved without loss of an excellent plating property of a graft copolymer (such as an ABS resin) and without loss of an excellent property (such as heat resistance or impact resistance) of an engineering resin. Note that the term “loss” herein means that a property of a resin composition is deteriorated to such a degree that the property does not satisfy a level demanded for the property. That is, even in a case where some property of the resin composition containing the graft copolymer and the engineering resin is deteriorated by addition of the flowability enhancing agent in accordance with an aspect of the present invention, this does not mean that the resin composition has lost the some property, provided that the some property satisfies a level demanded for a purpose of use of the resin composition. The above description can be rephrased as follows: “without substantial loss of an excellent plating property of a graft copolymer (such as an ABS resin) and without substantial loss of an excellent property (such as heat resistance or impact resistance) of an engineering resin.”

### DESCRIPTION OF EMBODIMENTS

The following description will discuss an embodiment of the present invention. Note, however, that the present invention is not limited to such an embodiment. The present invention is not limited to arrangements described below, and may be altered in various ways by a skilled person within the scope of the claims. Any embodiment and/or example derived from a proper combination of technical means disclosed in different embodiments and/or examples are/is also encompassed in the technical scope of the present invention. All academic and patent literatures listed herein are incorporated herein by reference. Unless otherwise specified herein, a numerical range expressed as “A to B” means “not less than A and not more than B.”

[1. Resin Composition]

A resin composition in accordance with an embodiment of the present invention is a resin composition including:

an engineering resin (I); a flowability enhancing agent (II); and a graft copolymer (III),

the graft copolymer (III) being a graft copolymer of a rubber polymer (a-1) and a monomer (a-2) which contains an aromatic vinyl monomer and a vinyl cyanide monomer,

the flowability enhancing agent (II) including a polyester which is a polycondensate of a monomer mixture containing biphenol (A) in a proportion of 0 mol % to 55 mol %, bisphenol (B) in a proportion of 5 mol % to 60 mol %, and dicarboxylic acid (C) in a proportion of 40 mol % to 60 mol %, with respect to 100 mol % of a total amount of the biphenol (A), the bisphenol (B), and the dicarboxylic acid (C),

the biphenol (A) being represented by the following general formula (1):

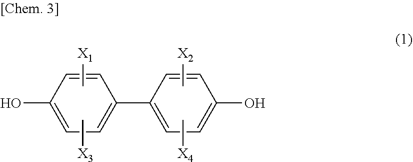

where X₁ through X₄ each independently represent a hydrogen atom, a halogen atom, or an alkyl group having 1 to 4 carbon atom(s) and may be identical to or different from each other,

the bisphenol (B) being represented by the following general formula (2):

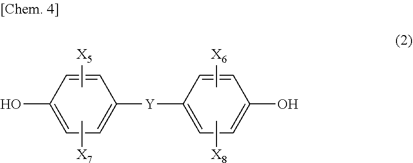

where: X₅ through X₈ each independently represent a hydrogen atom, a halogen atom, or an alkyl group having 1 to 4 carbon atom(s) and may be identical to or different from each other; and Y represents a methylene group, an isopropylidene group, a cyclic alkylidene group, an aryl-substituted alkylidene group, an arylenedialkylidene group, —S—, —O—, a carbonyl group, or —SO₂—, the dicarboxylic acid (C) being represented by the following general formula (3):

HOOC—R₁—COOH (3)

where R₁ represents a divalent linear substituent which has 2 to 18 atoms in its main chain and which may contain a branch.

<Engineering Resin (I)>

The engineering resin (I) in accordance with an embodiment of the present invention is not limited to any particular one, and can be a publicly known engineering resin. Examples of the engineering resin (I) include polycarbonate resin, polyester, polyphenylene ether, syndiotactic polystyrene, polyamide, polyarylate, polyphenylene sulfide, polyether ketone, polyether ether ketone, poly sulfone, polyether sulfone, polyamide imide, polyether imide, and polyacetal. Each of these engineering resins can be used solely. Alternatively, two or more of these engineering resins can be used in combination. Of these engineering resins, the polycarbonate resin is preferable in view of impact resistance.

The polycarbonate resin is not limited any particular one, and can be any of polycarbonate resins having various structural units. For example, the polycarbonate resin can be a polycarbonate resin produced by a method in which divalent phenol and carbonyl halide are subjected to interfacial polycondensation, a method in which divalent phenol and carbonic acid diester are subjected to melt polymerization (transesterification), or the like.

Examples of the divalent phenol, which is a raw material of the polycarbonate resin, include 4,4′-dihydroxybiphenyl, bis(4-hydroxyphenyl)methane, 1,1-bis(4-hydroxyphenyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 1,1-bis(4-hydroxyphenyl)cyclohexane, bis(4-hydroxyphenyl)ether, bis(4-hydroxyphenyl)sulfide, bis(4-hydroxyphenyl)sulfone, bis(4-hydroxyphenyl)sulfoxide, bis(4-hydroxyphenyl)ketone, hydroquinone, resorcin, and catechol. Of these divalent phenols, bis(hydroxyphenyl)alkanes are preferable, and divalent phenols obtained with use of 2,2-bis(4-hydroxyphenyl)propane as a main raw material are particularly preferable. Further, examples of a carbonate precursor include carbonyl halide, carbonyl ester, and haloformate. Specific examples include phosgene; diaryl carbonates such as divalent phenol dihaloformate, diphenyl carbonate, ditolyl carbonate, bis(chlorophenyl)carbonate, and m-cresyl carbonate; and aliphatic carbonate compounds such as dimethyl carbonate, diethyl carbonate, diisopropyl carbonate, dibutyl carbonate, diamyl carbonate, and dioctyl carbonate.

The polycarbonate resin can be a resin having a polymer chain whose molecular structure is a linear structure or can be alternatively a resin having a polymer chain whose molecular structure includes both a linear structure and a branched structure. Examples of a branching agent for introducing such a branched structure include 1,1,1-tris(4-hydroxyphenyl)ethane, α,α′,α″-tris(4-hydroxyphenyl)-1,3,5-triisopropylbenzene, phloroglucin, trimellitic acid, and isatinbis(o-cresol). Further, as a molecular weight regulator, phenol, p-t-butylphenol, p-t-octylphenol, p-cumylphenol, or the like can be used.

The polycarbonate resin used in an embodiment of the present invention can be a homopolymer produced with use of only the divalent phenol, can be alternatively a copolymer having a polycarbonate structural unit and a polyorganosiloxane structural unit, or can be alternatively a resin composition obtained from such a homopolymer and a copolymer. Alternatively, the polycarbonate resin can be a polyester-polycarbonate resin obtained by carrying out a polymerization reaction of divalent phenol and the like in the presence of bifunctional carboxylic acid (such as terephthalic acid) or an ester precursor thereof (such as an ester forming derivative).

In regard to a molecular weight, the polycarbonate resin has a viscosity average molecular weight of preferably 12000 to 40000, more preferably 15000 to 30000, still more preferably 18000 to 28000, and particularly preferably 20000 to 25000, in view of obtainment of the resin composition having high impact resistance. Note that the viscosity average molecular weight is determined by conversion of a solution viscosity measured at a temperature of 25° C. with use of methylene chloride as a solvent.

Further, a resin composition obtained by melting and kneading polycarbonate resins having various structural units can be also used. As a resin material containing a polycarbonate resin, a polycarbonate polymer alloy obtained from a combination of a polycarbonate resin and another resin (later described) or an elastomer can be used.

The resin composition in accordance with an embodiment of the present invention can contain another resin or an elastomer in such a range that excellent impact resistance, excellent heat resistance, excellent dimensional stability, an excellent self-extinguishing property (flame retardancy), and the like which the engineering resin (I) intrinsically has are not deteriorated, specifically, in a range of not more than 50 parts by mass with respect to 100 parts by mass of the engineering resin (I).

Examples of the elastomer include isobutylene-isoprene rubber; polyester elastomers; styrene elastomers such as styrene-butadiene rubber, polystyrene-polybutadiene-polystyrene (SBS), polystyrene-poly(ethylene-butylene)-polystyrene (SEBS), polystyrene-polyisoprene-polystyrene (SIS), and polystyrene-poly(ethylene-propylene)-polystyrene (SEPS); polyolefin elastomers such as ethylene-propylene rubber; polyamide elastomers; acrylic elastomers; and core-shell type impact resistance improvers containing diene rubber, acrylic rubber, silicone rubber, or the like, the core-shell type impact resistance improvers being typified by methyl methacrylate-butadiene-styrene resin (MBS resin) and methyl methacrylate-acrylonitrile-styrene resin (MAS resin).

<Flowability Enhancing Agent (II)>

The flowability enhancing agent (II) in accordance with an embodiment of the present invention includes a polyester which is a polycondensate of a monomer mixture containing, in specific proportions, bisphenol (B) represented by the following general formula (2) and aliphatic dicarboxylic acid (C) represented by the following general formula (3) and, optionally, biphenol (A) represented by the following general formula (1).

More specifically, the flowability enhancing agent (II) in accordance with an embodiment of the present invention includes a polyester (polycondensate) having, in its main chain structure, (i) a portion, derived from a biphenol component (A), in a proportion of 0 mol % to 55 mol %, (ii) a portion, derived from a bisphenol component (B), in a proportion of 5 mol % to 60 mol %, and (iii) a portion, derived from a dicarboxylic acid component (C), in a proportion of 40 mol % to 60 mol %, with respect to 100 mol % of a total amount of the biphenol component (A), the bisphenol component (B), and the dicarboxylic acid component (C),

the biphenol component (A) being represented by the following general formula (1):

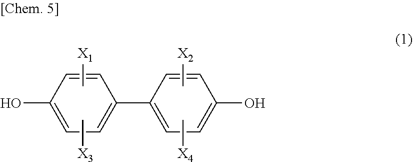

where X₁ through X₄ each independently represent a hydrogen atom, a halogen atom, or an alkyl group having 1 to 4 carbon atom(s) and may be identical to or different from each other,

the bisphenol component (B) being represented by the following general formula (2):

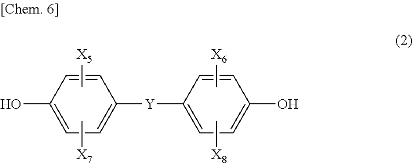

where: X₅ through X₈ each independently represent a hydrogen atom, a halogen atom, or an alkyl group having 1 to 4 carbon atom(s) and may be identical to or different from each other; and Y represents a methylene group, an isopropylidene group, a cyclic alkylidene group, an aryl-substituted alkylidene group, an arylenedialkylidene group, —S—, —O—, a carbonyl group, or —SO₂—, the dicarboxylic acid component (C) being represented by the following general formula (3):

HOOC—R₁—COOH (3)

where R₁ represents a divalent linear substituent which has 2 to 18 atoms in its main chain and which may contain a branch.

In the polyester in accordance with an embodiment of the present invention, the portion derived from the biphenol (A) represented by the general formula (1) will be referred to as a biphenol component (A), the portion derived from the bisphenol (B) represented by the general formula (2) will be referred to as a bisphenol component (B), and the portion derived from the dicarboxylic acid (C) represented by the general formula (3) will be referred to as a dicarboxylic acid component (C), in the following description.

The flowability enhancing agent (II) in accordance with an embodiment of the present invention can be prepared through polycondensation of the monomer mixture containing (i) the biphenol (A), represented by the general formula (1), in a proportion of 0 mol % to 55 mol %, (ii) the bisphenol (B), represented by the general formula (2), in a proportion of 5 mol % to 60 mol %, and (iii) the dicarboxylic acid (C), represented by the general formula (3), in a proportion of 40 mol % to 60 mol %, with respect to 100 mol % of the total amount of the biphenol (A), the bisphenol (B), and the dicarboxylic acid (C).

The flowability enhancing agent (II) is not a low molecular weight compound. It is therefore possible to suppress occurrence of bleedout of the flowability enhancing agent (II) while the resin composition containing the flowability enhancing agent (II) is molded.

The flowability enhancing agent (II) contains the biphenol component (A) in a proportion of 0 mol % to 55 mol %, preferably 10 mol % to 40 mol %, more preferably 20 mol % to 30 mol %, with respect to 100 mol % of the total amount of the biphenol component (A), the bisphenol component (B), and the dicarboxylic acid component (C). The flowability enhancing agent (II) contains the bisphenol component (B) in a proportion of 5 mol % to 60 mol %, preferably 10 mol % to 50 mol %, more preferably 20 mol % to 30 mol %, with respect to 100 mol % of the total amount of the biphenol component (A), the bisphenol component (B), and the dicarboxylic acid component (C). The flowability enhancing agent (II) contains the dicarboxylic acid component (C) in a proportion of 40 mol % to 60 mol %, preferably 45 mol % to 55 mol %, with respect to 100 mol % of the total amount of the biphenol component (A), the bisphenol component (B), and the dicarboxylic acid component (C). Note that these proportions correspond to respective proportions of monomers (i.e., the biphenol (A), the bisphenol (B), and the dicarboxylic acid (C)) which are contained in the monomer mixture that is subjected to the polycondensation so as to obtain the polyester included in the flowability enhancing agent (II) (note that the total amount of the biphenol (A), the bisphenol (B), and the dicarboxylic acid (C) is 100 mol %). Note also that, in a case where the flowability enhancing agent (II) contains the biphenol component (A), the flowability enhancing agent (II) can contain only one kind of biphenol component (A) or can alternatively contain two or more kinds of biphenol components (A). Similarly, the flowability enhancing agent (II) can contain only one kind of bisphenol component (B) or can alternatively contain two or more kinds of bisphenol components (B). Similarly, the flowability enhancing agent (II) can contain only one kind of dicarboxylic acid component (C) or can alternatively contain two or more kinds of dicarboxylic acid components (C). In a case where any of the components is made of two or more kinds of components, the proportion of the any of the components indicates a proportion of a total amount of the two or more kinds of components.

A diol component contained in the flowability enhancing agent (II) is made of the bisphenol component (B) and, optionally, the biphenol component (A). In a case where the diol component is made of the biphenol component (A) and the bisphenol component (B), a molar ratio ((A)/(B)) between the biphenol component (A) and the bisphenol component (B) is preferably 1/9 to 9/1, more preferably 1/7 to 7/1, still more preferably 1/5 to 5/1, and most preferably 1/3 to 3/1. In a case where the flowability enhancing agent (II) contains the biphenol component (A) in a higher proportion so that the molar ratio (A)/(B) is not less than 1/9, it is possible to prevent the polyester itself from becoming completely amorphous and possible to prevent a glass transition temperature of the flowability enhancing agent (II) from being lowered. This is preferable because it is possible to prevent pellets of the flowability enhancing agent (II) from being fused together during storage. In a case where the flowability enhancing agent (II) contains the bisphenol component (B) in a higher proportion so that the molar ratio (A)/ (B) is not more than 9/1, the flowability enhancing agent (II) has sufficient compatibility with the engineering resin (I). This is preferable because, in a case where the resin composition obtained by adding the flowability enhancing agent (II) to the engineering resin (I) is molded into a molded article having a thickness of not less than 4 mm, it is possible to prevent phase separation from occurring in a central part of the thickness of the molded article while the molded article is slowly cooled and, accordingly, possible to prevent various physical properties of the engineering resin (I) from being deteriorated.

X₁ through X₄ in the general formula (1) each independently represent a hydrogen atom, a halogen atom, or an alkyl group having 1 to 4 carbon atom(s) and may be identical to or different from each other. It is more preferable that X₁ through X₄ be all hydrogen atoms, in order to enhance crystallinity of the flowability enhancing agent (II) itself and to improve handleability of the flowability enhancing agent (II) (e.g., prevent the pellets from being fused together during the storage).

X₅ through X₈ in the general formula (2) each independently represent a hydrogen atom, a halogen atom, or an alkyl group having 1 to 4 carbon atom(s) and may be identical to or different from each other. It is more preferable that X₅ through X₈ be all hydrogen atoms, in order to enhance the compatibility of the flowability enhancing agent (II) with an aromatic polycarbonate resin. Y represents a methylene group, an isopropylidene group, a cyclic alkylidene group, an aryl-substituted alkylidene group, an arylenedialkylidene group, —S—, —O—, a carbonyl group, or —SO₂—.

As the bisphenol component represented by the general formula (2), 2,2-bis(4-hydroxyphenyl)propane [common name: bisphenol A] is particularly preferable in that such a bisphenol component causes the compatibility of the flowability enhancing agent (II) with the aromatic polycarbonate resin to be enhanced. Examples of divalent phenol other than the bisphenol A include: bis(hydroxyaryl)alkanes such as bis(4-hydroxyphenyl)methane, 1,1-bis(4-hydroxyphenyl)ethane, 2,2-bis(4-hydroxyphenyl)butane 2,2-bis(4-hydroxyphenyl)octane, 2,2-bis(4-hydroxy- 1-methylphenyl)propane, 1,1-bis (4-hydroxy-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane; bis(hydroxyaryl)arylalkanes such as 2,2-bis(4-hydroxyphenyl)phenylmethane and bis(4-hydroxyphenyl)naphthylmethane; bis(hydroxyaryl)cycloalkanes such as 1,1-bis(4-hydroxyphenyl)cyclopentane, 1,1-bis(4-hydroxyphenyl)cyclohexane, and 1,1-bis(4-hydroxyphenyl)-3,5,5-trimethylcyclohexane; dihydroxyarylethers such as 4,4′-dihydroxyphenylether and 4,4′-dihydroxy-3,3′-dimethylphenylether; dihydroxydiarylsulfides such as 4,4′-dihydroxydiphenylsulfide and 4,4′-dihydroxy-3,3′-dimethyldiphenylsulfide; dihydroxydiarylsulfoxides such as 4,4′-dihydroxydiphenylsulfoxide and 4,4′-dihydroxy-3,3′-dimethyldiphenylsulfoxide; dihydroxydiarylsulfones such as 4,4′-dihydroxydiphenylsulfone and 4,4′-dihydroxy-3,3′-dimethyldiphenylsulfone; and dihydroxydiphenyls such as 4,4′-dihydroxydiphenyl. Each of these bisphenol components can be used solely. Alternatively, two or more of these bisphenol components can be used in combination, provided that the two or more of these bisphenol components do not cause the effect of the present invention to be lost.

A terminal structure of the flowability enhancing agent (II) in accordance with an embodiment of the present invention is not particularly limited. However, it is preferable that part of terminals of the flowability enhancing agent (II) be each sealed with a monofunctional low molecular weight compound, particularly in order to (i) suppress transesterification of the flowability enhancing agent (II) with the engineering resin (I) so as to suppress yellowing of the resin composition obtained by adding the flowability enhancing agent (II) to the engineering resin (I) and the graft copolymer (III) and (ii) suppress hydrolysis of the flowability enhancing agent (II) with the engineering resin (I) so as to ensure long-term stability.

A sealing rate with respect to all terminals of a molecular chain is preferably not less than 60%, more preferably not less than 80%, still more preferably not less than 90%, and most preferably not less than 95%.

A terminal sealing rate of the flowability enhancing agent (II) can be determined by (i) measuring the number of sealed terminal functional groups and the number of unsealed terminal functional groups and (ii) substituting these numbers into the following expression (4). As a specific method for calculating the terminal sealing rate, a method in which (i) each of the number of sealed terminal functional groups and the number of unsealed terminal functional groups is determined from an integral value of a characteristic signal corresponding to the each of the number of sealed terminal functional groups and the number of unsealed terminal functional groups with use of ¹H-NMR and (ii) the terminal sealing rate is calculated, based on a result of such determination, with use of the following expression (4) is preferable in view of accuracy and simplicity.

Terminal sealing rate (%)={[the number of sealed terminal functional groups]/([the number of sealed terminal functional groups]+[the number of unsealed terminal functional groups])}×100 (4)

Examples of the monofunctional low molecular weight compound used for sealing include monovalent phenol, monoamine having 1 to 20 carbon atom(s), aliphatic monocarboxylic acid, carbodiimide, epoxy, and oxazoline. Specific examples of the monovalent phenol include phenol, p-cresol, p-t-butylphenol, p-t-octylphenol, p-cumylphenol, p-nonylphenol, p-t-amylphenol, 4-hydroxybiphenyl, and any mixture of such monovalent phenols. Specific examples of the aliphatic monocarboxylic acid include: aliphatic monocarboxylic acids such as acetic acid, propionic acid, butyric acid, valeric acid, caproic acid, caprylic acid, lauric acid, tridecanoic acid, myristic acid, palmitic acid, stearic acid, pivalic acid, and isobutyric acid; and any mixture of such aliphatic monocarboxylic acids. Of these aliphatic monocarboxylic acids, myristic acid, palmitic acid, and stearic acid are preferable because each of the myristic acid, the palmitic acid, and the stearic acid has a high boiling point and, accordingly, such a terminal sealing agent does not easily volatilize even under a high temperature condition during polymerization. Specific examples of the monoamine include: aliphatic monoamines such as methylamine, ethylamine, propylamine, butylamine, hexylamine, octylamine, decylamine, stearylamine, dimethylamine, diethylamine, dipropylamine, and dibutylamine; and any mixture of such monoamines. Examples of the carbodiimide include dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, naphthylcarbodiimide, bis-2,6-diisopropylphenylcarbodiimide, poly(2,4,6-triisopropylphenylene-1,3-diisocyanate), 1,5-(diisopropylbenzene)polycarbodiimide, 2,6,2′,6′-tetraisopropyldiphenylcarbodiimide, and any mixture of such carbodiimides. Examples of the epoxy include ethylene glycol diglycidyl ether, propylene glycol diglycidyl ether, neopentyl glycol diglycidyl ether, triethylolpropane polyglycidyl ether, glycerol diglycidyl ether, glycerol triglycidyl ether, sorbitol polyglycidyl ether, bisphenol A-diglycidyl ether, hydrogenated bisphenol A-glycidyl ether, 4,4′-diphenyl methane diglycidyl ether, terephthalic acid diglycidyl ester, isophthalic acid diglycidyl ester, methacrylic acid glycidyl ester, methacrylic acid glycidyl ester polymer, a methacrylic acid glycidyl ester polymer containing compound, and any mixture of such epoxies.

Examples of the oxazoline include styrene·2-isopropenyl-2-oxazoline, 2-isopropenyl-2-oxazoline, 1, 3-phenylenebis(2-oxazoline), and a mixture thereof.

R₁ in the following general formula (3) representing the component (C) represents a divalent linear substituent which has 2 to 18 atoms in its main chain and which may contain a branch.

HOOC—R₁—COOH (3)

Here, the number of atoms in the main chain is the number of atoms in a skeleton of the main chain. For example, in a case where —R₁— is —(CH₂)—, the number of atoms in the main chain is 8, which is the number of carbon atoms. R₁ is preferably a linear substituent which does not contain a branch, and more preferably a linear aliphatic hydrocarbon chain which does not contain a branch. This is because a melt viscosity of the flowability enhancing agent (II) itself is decreased. Further, R₁ may be saturated or unsaturated, but is preferably a saturated aliphatic hydrocarbon chain. In a case where R₁ contains an unsaturated bond, the flowability enhancing agent (II) may not have sufficient flexibility. This may cause an increase in the melt viscosity of the flowability enhancing agent (II) itself. In view of achievement of both of (i) easiness of polymerization of the flowability enhancing agent (II) and (ii) an increase in the glass transition point of the flowability enhancing agent (II), R₁ is preferably a linear saturated aliphatic hydrocarbon chain having 2 to carbon atoms, more preferably a linear saturated aliphatic hydrocarbon chain having 4 to 16 carbon atoms, still more preferably a linear saturated aliphatic hydrocarbon chain having 8 to 14 carbon atoms, and most preferably a linear saturated aliphatic hydrocarbon chain having 8 carbon atoms. The increase in the glass transition point of the flowability enhancing agent (II) causes enhancement of heat resistance of the resin composition obtained by adding the flowability enhancing agent (II) to the engineering resin (I) and the graft copolymer (III). In view of a decrease in the melt viscosity of the flowability enhancing agent (II) itself, the number of atoms in the main chain of R₁ is preferably an even number. In view the above, R₁ is particularly preferably one selected from —(CH₂)₈—, —(CH₂)₁₀— and —(CH₂)₁₂—. As the dicarboxylic acid component, only one kind of dicarboxylic acid component can be used. Alternatively, two or more kinds of dicarboxylic acid components can be used in combination, provided that the two or more kinds of dicarboxylic acid components do not cause the effect of the present invention to be lost.

The flowability enhancing agent (II) in accordance with an embodiment of the present invention can be copolymerized with another monomer, provided that such a copolymerization does not cause the effect of the flowability enhancing agent (II) to be lost. Examples of the another monomer include aromatic hydroxycarboxylic acid, aromatic dicarboxylic acid, aromatic diol, aromatic hydroxyamine, aromatic diamine, aromatic aminocarboxylic acid, caprolactams, caprolactones, aliphatic dicarboxylic acid, aliphatic diol, aliphatic diamine, alicyclic dicarboxylic acid, alicyclic diol, aromatic mercaptocarboxylic acid, aromatic dithiol, and aromatic mercaptophenol.

The flowability enhancing agent (II) contains the another monomer in a proportion of less than 50 mol %, preferably less than 30 mol %, more preferably less than 10 mol %, most preferably less than 5 mol %, with respect to the number of moles of the entire flowability enhancing agent (II). It is preferable that the flowability enhancing agent (II) contain the another monomer in a proportion of less than 50 mol % with respect to the number of moles of the entire flowability enhancing agent (II), because such a flowability enhancing agent (II) has good compatibility with the engineering resin (I) and is compatible with the engineering resin (I).

Specific examples of the aromatic hydroxycarboxylic acid include 4-hydroxybenzoic acid, 3-hydroxybenzoic acid, 2-hydroxybenzoic acid, 2-hydroxy-6-naphthoic acid, 2-hydroxy-5-naphthoic acid, 2-hydroxy-7-naphthoic acid, 2-hydroxy-3-naphthoic acid, 4′-hydroxyphenyl-4-benzoic acid, 3′-hydroxyphenyl-4-benzoic acid, and 4′-hydroxyphenyl-3-benzoic acid, each of which may or may not be substituted with alkyl, alkoxy, or halogen.

Specific examples of the aromatic dicarboxylic acid include terephthalic acid, isophthalic acid, 2,6-naphthalenedicarboxylic acid, 1,6-naphthalenedicarboxylic acid, 2,7-naphthalenedicarboxylic acid, 4,4′-dicarboxybiphenyl, 3,4′-dicarboxybiphenyl, 4,4″-dicarboxyterphenyl, bis(4-carboxyphenyl)ether, bis(4-carboxyphenoxy)butane, bis(4-carboxyphenyl)ethane, bis(3-carboxyphenyl)ether, and bis(3-carboxyphenyl)ethane, each of which may or may not be substituted with alkyl, alkoxy, or halogen.

Specific examples of the aromatic diol include pyrocatechol, hydroquinone, resorcin, 2,6-dihydroxynaphthalene, 2,7-dihydroxynaphthalene, 1,6-dihydroxynaphthalene, 3,3′-dihydroxybiphenyl, 3,4′-dihydroxybiphenyl, 4,4′-dihydroxybiphenyl, 4,4′-dihydroxybiphenol ether, bis(4-hydroxyphenyl)ethane, and 2,2′-dihydroxybinaphthyl, each of which may or may not be substituted with alkyl, alkoxy, or halogen.

Specific examples of the aromatic hydroxylamine include 4-aminophenol, N-methyl-4-aminophenol, 3-aminophenol, 3-methyl-4-aminophenol, 4-amino-1-naphthol, 4-amino-4′-hydroxybiphenyl, 4-amino-4′-hydroxybiphenyl ether, 4-amino-4′-hydroxybiphenyl methane, 4-amino-4′-hydroxybiphenyl sulfide, and 2,2′-diaminobinaphthyl, each of which may or may not be substituted with alkyl, alkoxy, or halogen.

Specific examples of the aromatic diamine and the aromatic aminocarboxylic acid include 1,4-phenylenediamine, 1,3-phenylenediamine, N-methyl- 1,4-phenylenediamine, N,N′-dimethyl-1,4-phenylenediamine, 4,4′-diaminophenyl sulfide (thiodianiline), 4,4′-diaminobiphenyl sulfone, 2,5-diaminotoluene, 4,4′-ethylenedianiline, 4,4′-diaminobiphenoxyethane, 4,4′-diaminobiphenyl methane (methylenedianiline), 4,4′-diaminobiphenyl ether (oxydianiline), 4-aminobenzoic acid, 3-aminobenzoic acid, 6-amino-2-naphthoic acid, and 7-amino-2-naphthoic acid, each of which may or may not be substituted with alkyl, alkoxy, or halogen.

Specific examples of the aliphatic dicarboxylic acid include oxalic acid, malonic acid, succinic acid, glutaric acid, adipic acid, pimelic acid, suberic acid, azelaic acid, sebacic acid, dodecanedioic acid, tetradecanedioic acid, fumaric acid, and maleic acid.

Specific examples of the aliphatic diamine include 1 ,2-ethylenediamine, 1,3-trimethylenediamine, 1,4-tetramethylenediamine, 1,6-hexamethylenediamine, 1,8-octanediamine, 1,9-nonanediamine, 1,10-decanediamine, and 1,12-dodecanediamine.

Specific examples of the alicyclic dicarboxylic acid, the aliphatic diol, and the alicyclic diol include: linear or branched aliphatic diols such as hexahydroterephthalic acid, trans-1,4-cyclohexanediol, cis- 1,4-cyclohexanediol, trans-1,4-cyclohexanedimethanol, cis-1,4-cyclohexanedimethanol, trans-1,3-cyclohexanediol, cis-1,2-cyclohexanediol, trans-1,3-cyclohexanedimethanol, ethylene glycol, propylene glycol, butylene glycol, 1,3-propanediol, 1,2-propanediol, 1,4-butanediol, 1,6-hexanediol, 1,8-octanediol, 1,10-decanediol, 1,12-dodecanediol, and neopentyl glycol; and reactive derivatives of such diols.

Specific examples of the aromatic mercaptocarboxylic acid, the aromatic dithiol, and the aromatic mercaptophenol include 4-mercaptobenzoic acid, 2-mercapto-6-naphthoic acid, 2-mercapto-7-naphthoic acid, benzene-1,4-dithiol, benzene-1,3-dithiol, 2,6-naphthalene-dithiol, 2,7-naphthalene-dithiol, 4-mercaptophenol, 3-mercaptophenol, 6-mercapto-2-hydroxynaphthalene, 7-mercapto-2-hydroxynaphthalene, and reactive derivatives of such compounds.

The flowability enhancing agent (II) in accordance with an embodiment of the present invention can contain, in advance, a phosphite antioxidant so that the resin composition having a good color tone can be obtained. Reasons why the resin composition having a good color tone can be obtained are as follows. That is, it is considered that the phosphite antioxidant (i) prevents discoloration of the flowability enhancing agent (II) itself and (ii) deactivates a polymerization catalyst used for the polymerization by which the flowability enhancing agent (II) is obtained, thereby preventing discoloration of the resin composition due to transesterification or a hydrolysis reaction between the flowability enhancing agent (II) and the engineering resin (I) which transesterification or hydrolysis reaction may occur when the flowability enhancing agent (II) and the engineering resin (I) are mixed together. This makes it possible to more effectively suppress a reduction in the molecular weight of the engineering resin (I) and, accordingly, makes it possible to enhance merely the flowability of the resin composition, containing the flowability enhancing agent (II), without loss of inherent properties of the engineering resin (I). The flowability enhancing agent (II) contains the phosphite antioxidant in an amount of preferably 0.005% by mass to 5% by mass, more preferably 0.01% by mass to 2% by mass, still more preferably 0.01% by mass to 1% by mass, and most preferably 0.02% by mass to 0.05% by mass, with respect to a weight of the flowability enhancing agent (II). The flowability enhancing agent (II) preferably contains the phosphite antioxidant in an amount of not less than 0.005% by mass, because the phosphite antioxidant in such an amount prevents coloring which occurs when the flowability enhancing agent (II) is added to the engineering resin (I) and the graft copolymer (III). Further, the flowability enhancing agent (II) preferably contains the phosphite antioxidant in an amount of not more than 5% by mass, in view of impact strength of the resin composition obtained by adding the flowability enhancing agent (II) to the engineering resin (I) and the graft copolymer (III).

As the phosphite antioxidant, various compounds are known. For example, various compounds are described in “Sanka Boshizai Handobukku (Antioxidant Handbook)” published by Taiseisha, “Kobunshizairyo no Rekka to Anteika (Degradation and Stabilization of Polymer Material)” (pages 235 to 242) published by CMC Publishing Co., Ltd., and the like. However, the phosphite antioxidant is not limited to these compounds. Examples of the phosphite antioxidant include tris(2,4-di-t-butylphenyl)phosphite, bis[2,4-bis(1,1-dimethylethyl)-6-methylphenyl]ethyl ester phosphorous acid, bis(2,4-di-t-butylphenyl)pentaerythritol diphosphite, bis(2,4-dicumylphenyl)pentaerythritol diphosphite, and bis(2,6-di-t-butyl-4-methylphenyl) pentaerythritol-di-phosphite. Examples of product names include: ADK STAB PEP-36, ADK STAB PEP-4C, ADK STAB PEP-8, ADK STAB PEP-8F, ADK STAB PEP-8W, ADK STAB PEP-11C, ADK STAB PEP-24G, ADK STAB HP-10, ADK STAB 2112, ADK STAB 260, ADK STAB P, ADK STAB QL, ADK STAB 522A, ADK STAB 329K, ADK STAB 1178, ADK STAB 1500, ADK STAB C, ADK STAB 135A, ADK STAB 3010, and ADK STAB TPP (each manufactured by ADEKA Corporation); and Irgafos 38, Irgafos 126, Irgafos 168, and Irgafos P-EPQ (each manufactured by BASF Japan Ltd.). Of these phosphite antioxidants, in particular, ADK STAB PEP-36, ADK STAB HP-10, ADK STAB 2112, ADK STAB PEP-24G, Irgafos 126, and the like are more preferable, because, for example, (i) such phosphite antioxidants can remarkably exhibit an effect of suppressing a transesterification reaction and the hydrolysis reaction and (ii) such phosphite antioxidants themselves have a high melting point and, accordingly, do not easily volatilize from a resin.

The flowability enhancing agent (II) in accordance with an embodiment of the present invention can contain, in advance, a hindered phenol antioxidant so that the resin composition having a good color tone can be obtained. The flowability enhancing agent (II) contains the hindered phenol antioxidant in an amount of preferably 0.005% by mass to 5% by mass, more preferably 0.01% by mass to 2% by mass, still more preferably 0.01% by mass to 1% by mass, and most preferably 0.02% by mass to 0.05% by mass, with respect to the weight of the flowability enhancing agent (II). The flowability enhancing agent (II) preferably contains the hindered phenol antioxidant in an amount of not less than 0.005% by mass, because the hindered phenol antioxidant in such an amount prevents coloring which occurs when the flowability enhancing agent (II) is added to the engineering resin (I) and the graft copolymer (III). The flowability enhancing agent (II) preferably contains the hindered phenol antioxidant in an amount of not more than 5% by mass, in view of the impact strength of the resin composition obtained by adding the flowability enhancing agent (II) to the engineering resin (I) and the graft copolymer (III). [0059]

Examples of the hindered phenol antioxidant include 2,6-di-t-butyl-4-methylphenol, 2,6-di-t-butyl-4-ethylphenol, mono (or di, or tri) (a-methylbenzyl)phenol, 2,2′-methylenebis(4-ethyl-6-t-butylphenol), methylenebis(4-methyl-6-t-butylphenol), 4,4′-butylidenebis(3-methyl-6-t-butylphenol), 4,4′-thiobis(3-methyl-6-t-butylphenol), 2,5-di-t-butylhydroquinone, 2,5-di-t-amylhydroquinone, triethylene glycol-bis-[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, pentaerythritol-tetrakis[3-(3,5-di-t-butyl-4-hydroxyphenyl)propionate], 2,2-thio-diethylene bis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamamide), 3, 5-di-t-butyl-4-hydroxy-benzylphosphonate-diethyl ester, 1,3,5-trimethyl-2,4,6-tris(3,5-di-t-butyl-4-hydroxybenzyl)benzene, calciumbis(ethyl 3,5-di-t-butyl-4-hydroxybenzylphosphonate), tris-(3,5-di-t-butyl-4-hydroxybenzyl)isocyanurate, 2,4-bis[(octylthio) methyl]o-cresol, N,N′-bis[3-(3,5-di-t-butyl-4-hydroxyphenyl)propionyl]hydrazine, tris(2,4-di-t-butylphenyl)phosphite, 2-(5-methyl-2-hydroxyphenyl)benzotriazole, 2-[2-hydroxy-3,5-bis (α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)-benzotriazole, a condensate of methyl-3-[3-t-butyl-5-(2H-benzotriazol-2-yl)-4-hydroxyphenyl]propionate and polyethylene glycol (having a molecular weight of about 300), hydroxyphenylbenzotriazole derivatives, 2-(3,5-di-t-butyl-4-hydroxybenzyl)-2-n-butyl malonate bis(1,2,2,6,6-pentamethyl-4-piperidyl), and 2,4-di-t-butylphenyl-3,5-di-t-butyl-4-hydroxybenzoate.

Examples of product names include: NOCRAC 200, NOCRAC M-17, NOCRAC SP, NOCRAC SP-N, NOCRAC NS-5, NOCRAC NS-6, NOCRAC NS-30, NOCRAC 300, NOCRAC NS-7, and NOCRAC DAH (each manufactured by Ouchi Shinko Chemical Industrial Co., Ltd.); ADK STAB AO-30, ADK STAB AO-40, ADK STAB AO-50, ADK STAB AO-60, ADK STAB AO-616, ADK STAB AO-635, ADK STAB AO-658, ADK STAB AO-80, ADK STAB AO-15, ADK STAB AO-18, ADK STAB 328, ADK STAB A0330, and ADK STAB AO-37 (each manufactured by ADEKA Corporation); IRGANOX-245, IRGANOX-259, IRGANOX-565, IRGANOX-1010, IRGANOX-1024, IRGANOX-1035, IRGANOX-1076, IRGANOX-1081, IRGANOX-1098, IRGANOX-1222, IRGANOX-1330, and IRGANOX-1425WL (each manufactured by BASF Japan Ltd.); and Sumilizer GA-80 (manufactured by Sumitomo Chemical Co., Ltd.). Of these hindered phenol antioxidants, ADK STAB AO-60, IRGANOX-1010, and the like are more preferable, because (i), in particular, such hindered phenol antioxidants themselves do not easily discolor and (ii) use of such hindered phenol antioxidants in combination with the phosphite antioxidant allows coloring of a resin to be efficiently suppressed.

Further, as a phenol antioxidant, a monoacrylate phenol stabilizer having both an acrylate group and a phenol group can be also used. Examples of the monoacrylate phenol stabilizer include 2-t-butyl-6-(3-t-butyl-2-hydroxy-5-methylbenzyl)-4-methylphenyl acrylate (product name: Sumilizer GM) and 2,4-di-t-amyl-6-[1-(3,5-di-t-amyl-2-hydroxyphenyl)ethyl]phenyl acrylate (product name: Sumilizer GS).

As a combination of the phosphite antioxidant and the hindered phenol antioxidant, a combination of (i) ADK STAB PEP-36, ADK STAB 2112, or Irgafos 126 and (ii) ADK STAB AO-60 or IRGANOX-1010 is preferable because such a combination allows coloring of a resin to be particularly suppressed.

A number average molecular weight of the flowability enhancing agent (II) in accordance with an embodiment of the present invention is a value measured by GPC at 80° C. with use of (i) polystyrene as a standard substance and (ii) a solution prepared by dissolving the resin, that is, the flowability enhancing agent (II) in accordance with an embodiment of the present invention in a mixed solvent, containing p-chlorophenol and toluene at a volume ratio of 3:8, such that a concentration of the resin, that is, the flowability enhancing agent (II) is 0.25% by mass. The flowability enhancing agent (II) in accordance with an embodiment of the present invention has a number average molecular weight of preferably 2000 to 30000, more preferably 3000 to 25000, and still more preferably 4000 to 22000. The flowability enhancing agent (II) preferably has a number average molecular weight of not less than 2000, because such a flowability enhancing agent (II) is prevented from bleeding out while, for example, the resin composition, obtained by adding the flowability enhancing agent (II) to the engineering resin (I) and the graft copolymer (III), is molded. Further the flowability enhancing agent (II) preferably has a number average molecular weight of not more than 30000, because the melt viscosity of such a flowability enhancing agent (II) itself is prevented from being excessively high and, accordingly, such a flowability enhancing agent (II) can effectively enhance the flowability of the resin composition, obtained by adding the flowability enhancing agent (II) to the engineering resin (I) and the graft copolymer (III), while the resin composition is molded.

The flowability enhancing agent (II) in accordance with an embodiment of the present invention can be produced by any publicly known method. One example of a method for producing the flowability enhancing agent (II) is a method in which hydroxyl groups of the monomers are each individually or collectively converted to lower fatty acid ester with use of lower fatty acid such as acetic anhydride and then lower fatty acid-eliminating polycondensation reactions between the lower fatty acid ester and carboxylic acid are carried out in separate reaction vessels or in an identical reaction vessel. The polycondensation reaction is carried out in a state in which no solvent is substantially present, at a temperature of usually 220° C. to 330° C. and preferably 240° C. to 310° C., in the presence of an inert gas such as a nitrogen gas, under an ordinary pressure or a reduced pressure, for 0.5 hours to 5 hours. In a case where a reaction temperature is lower than 220° C., the polycondensation reaction progresses slowly. In a case where the reaction temperature is higher than 330° C., a side reaction such as decomposition is likely to occur. In a case where the polycondensation reaction is carried out under the reduced pressure, it is preferable to reduce a pressure stepwise. In a case where the pressure is rapidly reduced so that a degree of vacuum becomes high, the dicarboxylic acid monomer or the low molecular weight compound, which is used to seal the terminals, volatilizes and, accordingly, it may not be possible to obtain a resin having a desired composition or a desired molecular weight. An ultimate degree of vacuum is preferably not more than 40 Torr, more preferably not more than 30 Torr, still more preferably not more than 20 Torr, and particularly preferably not more than 10 Torr. In a case where the ultimate degree of vacuum is higher than 40 Torr, acid elimination does not proceed sufficiently. This may cause polymerization time to be longer, thereby causing the resin to be colored. The polycondensation reaction can be carried out at multi-stage reaction temperatures. Alternatively, in some cases, the polycondensation reaction can be carried out in such a manner that a reaction product in a melted state is taken out and collected while the reaction temperature is increasing or immediately after the reaction temperature reaches a maximum temperature. A polyester resin thus obtained can be used as it is, or can be alternatively used after removal of an unreacted raw material or after being subjected to solid phase polymerization so as to improve physical properties of the polyester resin. In a case where the solid phase polymerization is carried out, it is preferable that (i) the polyester resin thus obtained be mechanically crushed into particles having a particle diameter of not more than 3 mm, preferably not more than 1 mm and then (ii) the particles of the polyester resin in a solid-phase state be processed for 1 hour to 30 hours at a temperature of 100° C. to 350° C. under an atmosphere of an inert gas, such as nitrogen, or under a reduced pressure. The particles of the polyester resin preferably have a particle diameter of not more than 3 mm so that a sufficient process is carried out and a problem is prevented from occurring with the physical properties. It is preferable that a processing temperature and a rate of temperature increase during the solid phase polymerization be selected such that fusion of the particles of the polyester resin does not occur.

Examples of an acid anhydride of the lower fatty acid used to produce the flowability enhancing agent (II) in accordance with an embodiment of the present invention include acid anhydrides of lower fatty acids having 2 to 5 carbon atoms, such as acetic anhydride, propionic anhydride, monochloroacetic anhydride, dichloroace tic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, butyric anhydride, isobutyric anhydride, valeric anhydride, and pivalic anhydride. Of these acid anhydrides, acetic anhydride, propionic anhydride, and trichloroacetic anhydride are suitably used. The acid anhydride of the lower fatty acid is used in an amount of 1.01 equivalents to 1.5 equivalents, and preferably 1.02 equivalents to 1.2 equivalents, with respect to a sum of functional groups, such as hydroxyl groups, of the monomers and the terminal sealing agent to be used. In a case where the acid anhydride of the lower fatty acid is used in an amount of less than 1.01 equivalents, the acid anhydride of the lower fatty acid volatilizes and, accordingly, the functional groups such as hydroxyl groups may insufficiently react with an anhydride of the lower fatty acid, so that a resin having a low molecular weight may be obtained.

A polymerization catalyst can be used to produce the flowability enhancing agent (II) in accordance with an embodiment of the present invention. As the polymerization catalyst, a catalyst conventionally publicly known as a polymerization catalyst for polyester can be used. Examples of the polymerization catalyst include: metal salt catalysts such as magnesium acetate, stannous acetate, tetrabutyl titanate, lead acetate, sodium acetate, potassium acetate, and antimony trioxide; and organic compound catalysts such as N,N-dimethylaminopyridine and N-methyl imidazole. Of these polymerization catalysts, sodium acetate, potassium acetate, and magnesium acetate are more preferable, because such polymerization catalysts allow (i) discoloration of the flowability enhancing agent (II) itself to be prevented and (ii) discoloration of the resin composition in accordance with an embodiment of the present invention to be prevented.

The smaller an amount of the polymerization catalyst is, the more the reduction in the molecular weight of the engineering resin (I) or yellowing of the engineering resin (I) can be suppressed. Therefore, the amount of the polymerization catalyst is usually 0% by mass to 100×10⁻²% by mass, preferably 0.5×10⁻³% by mass to 50×10⁻²% by mass, with respect to a total weight of the polyester resin.

The flowability enhancing agent (II) in accordance with an embodiment of the present invention is not limited to any particular shape or form. For example, the flowability enhancing agent (II) can have a pellet-like, flake-like, or powder-like shape or form. A particle diameter of the flowability enhancing agent (II) only needs to be so small that the flowability enhancing agent (II) can be introduced into an extruder in which the flowability enhancing agent (II) is melted and kneaded with the engineering resin (I) and the graft copolymer (III), and is preferably not more than 6 mm. <Graft Copolymer (III)>

The graft copolymer (III) in accordance with an embodiment of the present invention is a graft copolymer of a rubber polymer (a-1) and a monomer (a-2) which contains an aromatic vinyl monomer and a vinyl cyanide monomer. That is, the graft copolymer (III) is obtained by polymerizing the monomer (a-2), which contains an aromatic vinyl monomer and a vinyl cyanide monomer, in the presence of the rubber polymer (a-1).

Examples of the rubber polymer (a-1) include: diene rubbers such as polybutadiene; alkyl (meth)acrylate rubbers such as butyl acrylic rubber; ethylene-propylene copolymer rubbers such as ethylene-propylene rubber;

polyorganosiloxane rubbers; diene/alkyl (meth)acrylate composite rubbers; polyorganosiloxane/ alkyl (meth)acrylate composite rubbers; and polyorganosiloxane/diene composite rubbers. Each of these rubber polymers can be used solely as the rubber polymer (a-1). Alternatively, two or more of these rubber polymers can be used in combination. The rubber polymer (a-1) is preferably a diene rubber (such as polybutadiene), a diene/alkyl (meth)acrylate composite rubber, or a polyorganosiloxane/diene composite rubber so that a better plating property is retained.

Examples of the aromatic vinyl monomer contained in the monomer (a-2) include styrene, α-methylstyrene, para-methylstyrene, and bromostyrene. Of these aromatic vinyl monomers, styrene is preferable. Each of these aromatic vinyl monomers can be used solely. Alternatively, two or more of these aromatic vinyl monomers can be used in combination.

Examples of the vinyl cyanide monomer contained in the monomer (a-2) include acrylonitrile and methacrylonitrile. Of these vinyl cyanide monomers, acrylonitrile is preferable. Each of these vinyl cyanide monomers can be used solely. Alternatively, two or more of these vinyl cyanide monomers can be used in combination.

A proportion in which the monomer (a-2) contains the aromatic vinyl monomer is not limited to any particular proportion. Similarly, a proportion in which the monomer (a-2) contains the vinyl cyanide monomer is not limited to any particular proportion. These proportions can be set to, for example, respective publicly known proportions.

The monomer (a-2) can contain another monomer, other than the aromatic vinyl monomer and the vinyl cyanide monomer, as necessary. Examples of the another monomer include: (meth)acrylates such as methyl methacrylate and methyl acrylate; maleimide compounds such as N-phenylmaleimide and N-cyclohexylmaleimide; and unsaturated carboxylic acid compounds such as acrylic acid, methacrylic acid, itaconic acid, and fumaric acid. Each of these monomers can be used solely as the another monomer. Alternatively, two or more of these monomers can be used in combination.

The graft copolymer (III) contains the rubber polymer (a-1) in a proportion of, but is not limited to, preferably 30% by mass to 85% by mass, in that the effect of the present invention is more easily brought about (note that a total amount of the rubber polymer (a-1) and the monomer (a-2) is 100% by mass).

Moreover, the graft copolymer (III) contains the rubber polymer (a-1) in a proportion of more preferably 45% by mass to 80% by mass, still more preferably 50% by mass to 80% by mass, in view of (i) enhancement of the melt flowability of the resin composition in accordance with an embodiment of the present invention and enhancement of impact resistance of a molded article in accordance with an embodiment of the present invention, (ii) suppression of occurrence of a fine powder of the graft copolymer (III), and (iii) prevention of blocking.

The graft copolymer (III) can be produced by a publicly known polymerization method. Examples of the polymerization method include a method in which (i) a latex of the rubber polymer (a-1) is mixed with part or all of the monomer (a-2) so that the rubber polymer (a-1) is impregnated with the part or all of the monomer (a-2) and then (ii) a resultant mixture is polymerized. According to such a polymerization method, balance between (i) large-size moldability of the resin composition and (ii) the physical properties, such as impact resistance, of the resin composition becomes good.

Specifically, the graft copolymer (III) is produced by the following method. That is, the latex of the rubber polymer (a-1) which latex has been produced by emulsion polymerization is introduced into a reactor equipped with a jacket and a stirring device. The part or all of the monomer (a-2) is then added to the latex at a time or continuously dropped into the latex, and a resultant mixture is left to stand at a temperature of 40° C. to 70° C. while being stirred. Time during which the mixture is left to stand (i.e., time during which the rubber polymer (a-1) is impregnated with the part or all of the monomer (a-2)) is preferably approximately 5 minutes to 60 minutes. Subsequently, an initiator is added to the mixture, and a remaining part of the monomer (a-2) is added to the mixture in a case where the part of the monomer (a-2) is used in a previous step.

The monomer (a-2) which is added before the initiator is added is impregnated into the rubber polymer (a-1), and polymerizes within the rubber polymer (a-1), so that the monomer (a-2) becomes a polymer within the rubber polymer (a-1).

A proportion in which each of the engineering resin (I), the flowability enhancing agent (II), and the graft copolymer (III) is contained in the resin composition in accordance with an embodiment of the present invention is not limited to any particular proportion. According to one example, the resin composition in accordance with an embodiment of the present invention preferably contains the engineering resin (I) in a proportion of 40% by mass to 90% by mass, the flowability enhancing agent (II) in a proportion of 1% by mass to 20% by mass, and the graft copolymer (III) in a proportion of 10% by mass to 60% by mass, with respect to 100% by mass of the total amount of the engineering resin (I), the flowability enhancing agent (II), and the graft copolymer (III).

The resin composition contains the engineering resin (I) in a proportion of more preferably 50% by mass to 80% by mass, still more preferably 60% by mass to 70% by mass, with respect to 100% by mass of the total amount of the engineering resin (I), the flowability enhancing agent (II), and the graft copolymer (III) so that the heat resistance and the impact resistance of the resin composition are maintained and the flowability of the resin composition during molding is enhanced.

The resin composition contains the flowability enhancing agent (II) in a proportion of more preferably 3% by mass to 15% by mass, still more preferably 5% by mass to 10% by mass, with respect to 100% by mass of the total amount of the engineering resin (I), the flowability enhancing agent (II), and the graft copolymer (III) so that the flowability of the resin composition is enhanced without a significant deterioration of the heat resistance of the resin composition. The flowability enhancing agent (II) in accordance with an embodiment of the present invention has a low glass transition temperature. Therefore, by causing the resin composition to contain the flowability enhancing agent (II) in a proportion of not more than 20% by mass, it is possible to prevent a glass transition point of the resin composition from being considerably lowered. The resin composition contains the graft copolymer (III) in a proportion of more preferably 20% by mass to 50% by mass, still more preferably 30% by mass to 40% by mass, with respect to 100% by mass of the total amount of the engineering resin (I), the flowability enhancing agent (II), and the graft copolymer (III) so that the plating property of the resin composition is ensured without a significant deterioration of the heat resistance or the impact resistance of the resin composition.

The resin composition in accordance with an embodiment of the present invention can further contain a phosphite antioxidant, regardless of whether or not the flowability enhancing agent (II) contains, in advance, the phosphite antioxidant. The resin composition contains the phosphite antioxidant in an amount of preferably 0.005 parts by mass to 5 parts by mass, more preferably 0.01 parts by mass to 2 parts by mass, still more preferably 0.01 parts by mass to 1 part by mass, most preferably 0.02 parts by mass to 0.05 parts by mass, with respect to 100 parts by mass of the resin composition so that a deterioration of the resin composition due to heat is prevented without a reduction in strength of the resin composition.

The resin composition in accordance with an embodiment of the present invention can further contain a hindered phenol antioxidant, regardless of whether or not the flowability enhancing agent (II) contains, in advance, the hindered phenol antioxidant. The resin composition contains the hindered phenol antioxidant in an amount of preferably 0.005 parts by mass to 5 parts by mass, more preferably 0.01 parts by mass to 2 parts by mass, still more preferably 0.01 parts by mass to 1 part by mass, most preferably 0.02 parts by mass to 0.05 parts by mass, with respect to 100 parts by mass of the resin composition so that a deterioration of the resin composition due to heat is prevented without a reduction in strength of the resin composition.

As another component, any other component such as an additive (e.g., a reinforcer, a thickner, a mold release, a coupling agent, a flame retarder, a flame-resistant agent, a pigment, a coloring agent, and the other auxiliary agents) or a filler can be added to the resin composition in accordance with an embodiment of the present invention, depending on a purpose, provided that the effect of the present invention is not lost. These additives are preferably used in an amount of 0 parts by mass to 100 parts by mass in total with respect to 100 parts by mass of the resin composition.

The flame retarder is used in an amount of more preferably 7 parts by mass to 80 parts by mass, still more preferably 10 parts by mass to 60 parts by mass, particularly preferably 12 parts by mass to 40 parts by mass, with respect to 100 parts by mass of the resin composition in accordance with an embodiment of the present invention. As the flame retarder, various compounds are known. For example, various compounds are described in “Kobunshi Nannenka no Gijutsu to Oyo (Technique and Application of Polymer Flame Retardation)” (pages 149 to 221), published by CMC Publishing Co., Ltd., and the like. However, the flame retarder is not limited to these compounds. Of these flame retarders, a phosphorus flame retarder, a halogen flame retarder, an inorganic flame retarder can be preferably used.

Specific examples of the phosphorus flame retarder include phosphoric ester, halogen-containing phosphoric ester, condensed phosphoric ester, polyphosphate, and red phosphorus. Each of these phosphorus flame retarders can be used solely. Alternatively, two or more of these phosphorus flame retarders can be used in combination.

Specific examples of the halogen flame retarder include brominated polystyrene, brominated polyphenylene ether, brominated bisphenol type epoxy polymers, brominated styrene maleic anhydride polymers, brominated epoxy resin, brominated phenoxy resin, decabromodiphenyl ether, decabromobiphenyl, brominated polycarbonate, perchlorocyclopentadecane, and brominated crosslinked aromatic polymers. Of these halogen flame retarders, brominated polystyrene and brominated polyphenylene ether are particularly preferable. Each of these halogen flame retarders can be used solely. Alternatively, two or more of these halogen flame retarders can be used in combination. Each of these halogen flame retarders contains a halogen element in an amount of preferably 15% to 87%.

An inorganic filler can be further added to the resin composition in accordance with an embodiment of the present invention so that mechanical strength, dimensional stability, and the like of the resin composition are enhanced or so that volume of the resin composition is increased.

Examples of the inorganic filler include: metal sulfate compounds such as zinc sulfate, potassium hydrogen sulfate, aluminum sulfate, antimony sulfate, sulfuric ester, potassium sulfate, cobalt sulfate, sodium hydrogen sulfate, iron sulfate, copper sulfate, sodium sulfate, nickel sulfate, barium sulfate, magnesium sulfate, and ammonium sulfate; titanium compounds such as titanium oxide; carbonate compounds such as potassium carbonate; metal hydroxide compounds such as aluminum hydroxide and magnesium hydroxide; silica compounds such as synthetic silica and natural silica; calcium aluminate, dihydrate gypsum, zinc borate, barium metaborate, and borax; nitric acid compounds (e.g., sodium nitrate), molybdenum compounds, zirconium compounds, antimony compounds, and modified products thereof; and composite fine particles of silicon dioxide and aluminum oxide.

Further, the other examples of the inorganic filler include potassium titanate whiskers, mineral fibers (such as rock wool), glass fibers, carbon fibers, metal fibers (such as stainless steel fibers), aluminum borate whiskers, silicon nitride whiskers, boron fibers, tetrapod-like zinc oxide whiskers, talc, clay, kaolin clay, natural mica, synthetic mica, pearl mica, aluminum foil, alumina, glass flakes, glass beads, glass balloon, carbon black, graphite, calcium carbonate, calcium sulfate, calcium silicate, titanium oxide, zinc oxide, silica, asbestos, and quartz powder.

Each of these inorganic fillers can be untreated or can be alternatively subjected to a chemical or physical surface treatment in advance. Examples of a surface treatment agent used for such a surface treatment include silane coupling agent-based compounds, higher fatty acid compounds, fatty acid metal salt compounds, unsaturated organic acid compounds, organic titanate compounds, resin acid compounds, and polyethylene glycol compounds.

A method for producing the resin composition in accordance with an embodiment of the present invention is not limited to any particular method. The resin composition is produced by a publicly known method in which the engineering resin (I), the flowability enhancing agent (II), and the graft copolymer (III) are blended and melted and kneaded with use of, for example, a device such as a Henschel mixer, a Banbury mixer, a single screw extruder, a twin screw extruder, a two-roll mill, a kneader, or a Brabender. A temperature at which the engineering resin (I), the flowability enhancing agent (II), and the graft copolymer (III) are melted and kneaded is preferably as low as possible for a purpose of prevention of yellowing of the resin composition which yellowing is caused by, for example, (i) a transesterification reaction between the flowability enhancing agent (II) and the engineering resin (I) and (ii) a deterioration of the engineering resin (I) due to heat.

[2. Molded Article]

A molded article in accordance with an embodiment of the present invention is obtained by molding a resin composition in accordance with an embodiment of the present invention.

By variously extrusion-molding the resin composition in accordance with an embodiment of the present invention, it is possible to mold the resin composition into, for example, variously shaped extrusion molded articles, an extrusion molded sheet, an extrusion molded film, and the like, each of which is the molded article in accordance with an embodiment of the present invention. Examples of such various extrusion molding methods include a cold runner molding method and a hot runner molding method as well as injection molding methods such as injection compression molding, injection press molding, gas-assisted injection molding, foam molding (including a case where a supercritical fluid is injected), insert molding, in-mold coating molding, heat-insulated mold molding, rapid heating/cooling mold molding, two color molding, sandwich molding, and ultra-high-speed injection molding. Alternatively, an inflation method, a calendar method, a casting method, or the like can be also employed so as to mold the resin composition into a sheet or a film. Furthermore, it is possible to mold the resin composition into a heat shrinkable tube by conducting a specific stretching operation. Further, it is possible to mold the resin composition in accordance with an embodiment of the present invention into a hollow molded article by, for example, rotation-molding or blow-molding the resin composition.

[3. Plated Molded Article]

A plated molded article in accordance with an embodiment of the present invention is obtained by plating a molded article in accordance with an embodiment of the present invention.

A method for plating the molded article in accordance with an embodiment of the present invention is not limited to any particular method, and a publicly known method can be, for example, employed.

The resin composition in accordance with an embodiment of the present invention has extremely high industrial practical value as a molding material to be molded into, for example, a large component of a motor vehicle, and is extremely useful as a plating molding material to be used for an exterior, such as a door mirror and a radiator grille, of a motor vehicle.

### EXAMPLES

The following description will discuss, in more detail, a resin composition in accordance with an embodiment of the present invention with reference to Example and Comparative Example. Note, however, that the present invention is not limited to such Example. Note that reagents manufactured by Wako Pure Chemical Industries, Ltd. were used below without being refined, unless otherwise specified.

<Evaluation Method>[Method for Measuring Number Average Molecular Weight]

A sample solution was prepared by dissolving a flowability enhancing agent (polyester) in accordance with an embodiment of the present invention in a mixed solvent, containing p-chlorophenol (manufactured by Tokyo Chemical Industry Co., Ltd.) and toluene at a volume ratio of 3:8, so that a concentration of the flowability enhancing agent became 0.25% by mass. Polystyrene was used as a standard substance, and a similar sample solution was prepared. Then, a number average molecular weight of the flowability enhancing agent was measured at a column temperature of 80° C. and a flow rate of 1.00 mL/minute with use of a high temperature GPC (350 HT-GPC System manufactured by Viscotek Co.). A differential refractometer (RI) was used as a detector.

[Method for Measuring Flowability]

A spiral flow (mm) of a resin composition was evaluated with use of an injection molding machine (IS-100, manufactured by Toshiba Machine Co., Ltd.). The resin composition was molded at a molding temperature of 280° C., a mold temperature of 100° C., and an injection pressure of 200 MPa. A molded article had a thickness of 1 mm and a width of 10 mm. [Method for Measuring Deflection Temperature Under Load]

A deflection temperature (° C.) under load of the resin composition was measured with use of HOT.TESTER S-3 (manufactured by TOYO SEIKI SEISAKU-SHO, LTD) according to JIS K7191 (test conditions: load 1.8 MPa, a rate of temperature increase 120° C./hour) so as to evaluate heat resistance.

[Method for Measuring Tensile Yield Strength]

Tensile yield strength was measure at a temperature of 23° C. according to ISO527-1 and ISO527-2.

[Method for Measuring Impact Strength]

Impact strength of the resin composition was measured according to ASTM D-256 (test conditions: 1/8 inches, with a notch, a temperature of 23° C.).

<Materials Used>

[Engineering Resin (I)]

(I-1) Polycarbonate: Panlite L1225Y (manufactured by TEIJIN LIMITED)

[Graft Copolymer (III)]

(III-1) ABS resin: STYLAC ABS191 (ASAHIKASEI CHEMICALS CORPORATION)

[Antioxidant]
Phosphite antioxidant: PEP36 (manufactured by ADEKA Corporation)
Hindered phenol antioxidant: A060 (manufactured by ADEKA Corporation)

[Flowability Enhancing Agent (II)]

### Production Example 1

In a sealed reactor equipped with a reflux condenser, a thermometer, a nitrogen gas inlet tube, and a stirring bar, 4,4′-dihydroxybiphenyl, bisphenol A, and sebacic acid at a molar ratio of 20:30.02:50 were introduced. Then, 1.05 equivalents of acetic anhydride with respect to phenolic hydroxyl groups in such monomers was added, and AO330 (manufactured by ADEKA Corporation) serving as an antioxidant was added. The monomers were reacted at an ordinary pressure, under a nitrogen gas atmosphere, and at a temperature of 145° C. so that a homogeneous solution was obtained. Thereafter, the temperature was increased to 240° C. at a rate of 2° C./minute while generated acetic acid was distilled off, and the solution was stirred at a temperature of 240° C. for 2 hours. While the temperature was kept at 240° C., the pressure was reduced to 5 Torr over about 60 minutes and then a reduced pressure state was maintained. After 3 hours from a start of a reduction in the pressure, the pressure inside the sealed reactor was returned to the ordinary pressure with use of a nitrogen gas, and a flowability enhancing agent was taken out from the reactor. The flowability enhancing agent thus obtained had a number average molecular weight of 22,000. It was determined by NMR that terminals of the flowability enhancing agent did not have a carboxylic acid component and were all sealed with acetyl groups. The flowability enhancing agent thus obtained was referred to as (II-1).

### Example 1, Comparative Example 1

An engineering resin (I), a flowability enhancing agent (II), a graft copolymer (III), and stabilizers (0.2 parts of PEP36 (manufactured by ADEKA Corporation, A-1) and 0.2 parts of A060 (manufactured by ADEKA Corporation, A-2)) were blended in proportions (parts by weight) shown in Table 1, supplied to a twin screw extruder, and then melted and kneaded at a temperature of 260° C. As a result, a resin composition was obtained. Table 1 also shows physical properties of the resin composition thus obtained.

A surface of a dumbbell-shaped molded article for measurement of tensile yield strength was plated by procedures (1) through (15) below, and the surface thus plated was observed with the naked eye. As a result, the resin composition of each of Example 1 and Comparative Example 1 had a good plating property. It was found that this was derived from a fact that the resin composition contained the graft copolymer (III). Furthermore, it was found that the flowability enhancing agent (II) did not cause a deterioration of the plating property.

(1) Degreasing step (60° C., 3 minutes)

(2) Washing with water

(3) Etching (etching was carried out at 65° C. for 15 minutes with use of a mixed solution of 400g/L of CrO₃ and 200 cc/L of H₂SO₄)

(4) Washing with water

(5) Acid treatment (ordinary temperature, 1 minute)

(6) Washing with water

(7) Catalyzing treatment (25° C., 3 minutes)

(8) Washing with water

(9) Activation treatment (40° C., 5 minutes)

(10) Washing with water

(11) Chemical Ni plating (40° C., 5 minutes)

(12) Washing with water

(13) Electroplating with copper (film thickness of 35 μm, 20° C., 60 minutes)

(14) Washing with water

(15) Drying

TABLE 1

| | | | | Comparative |
|---|---|---|---|---|
| | | | Example | Example |
| | | | 1 | 1 |
| Proportion | Engineering resin | (I-1) | 65 | 70 |
| (Parts by | Flowability | (II-1) | 5 | 0 |
| weight) | enhancing agent | | | |
| | Graft copolymer | (III-1) | 30 | 30 |
| | Stabilizer | (A-1) | 0.2 | 0.2 |
| | | (A-2) | 0.2 | 0.2 |

| | | | |
|---|---|---|---|
| Evaluation | Spiral flow (mm) | 335 | 285 |
| results | Deflection temperature | 116 | 124 |
| | under load (° C.) | | |
| | Tensile yield strength (MPa) | 60 | 59 |
| | Impact strength (J/m) | 380 | 420 |

The resin composition produced in Example 1 and the resin composition produced in Comparative Example 1 were resin compositions produced by a similar method, and had an identical composition, except that the resin composition produced in Example 1 contained the flowability enhancing agent (see Table 1). According to a comparison between results of evaluation of the physical properties of those resin compositions, it was found that the heat resistance, the tensile yield strength, and the impact strength of the resin composition produced in Example 1 were substantially equal to those of the resin composition produced in Comparative Example 1 and that the flowability (spiral flow) of the resin composition produced in Example 1 was more excellent than that of the resin composition produced in Comparative Example 1.

In other words, it was found that the heat resistance, the tensile yield strength, and the impact strength of the resin composition, containing the flowability enhancing agent and the graft copolymer, in accordance with an embodiment of the present invention are not deteriorated and the flowability (spiral flow) of the resin composition in accordance with an embodiment of the present invention is improved, as compared with a conventional resin composition which contains the graft copolymer but does not contain the flowability enhancing agent.

### INDUSTRIAL APPLICABILITY

A resin composition in accordance with an embodiment of the present invention has excellent impact resistance, an excellent plating property, and excellent melt flowability (moldability). Furthermore, it is possible to easily and stably mold, from the resin composition in accordance with an embodiment of the present invention, a molded article having excellent physical properties and having any shape, including an intricately shaped molded article and a thin molded article. As such, the resin composition in accordance with an embodiment of the present invention is extremely industrially useful.

The molded article obtained by molding the resin composition in accordance with an embodiment of the present invention has (i) dramatically improved melt flowability as compared with a molded article obtained by molding a conventional resin composition, (ii) high impact resistance, and (iii) an excellent plating property. It is therefore possible to use the molded article for, for example, an exterior, such as a door mirror and a radiator grille, of a motor vehicle.

1. A resin composition, comprising:
an engineering resin;
a flowability enhancing agent; and
a graft copolymer,
wherein the graft copolymer is a graft copolymer of a rubber polymer and a monomer comprising an aromatic vinyl monomer and a vinyl cyanide monomer,
the flowability enhancing agent comprises a polyester which is a polycondensate of a monomer mixture including 0 mol % to 55 mol % of a biphenol (A), 5 mol % to 60 mol % of a bisphenol (B), and 40 mol % to 60 mol % of a dicarboxylic acid (C), with respect to 100 mol % of a total amount of the biphenol (A), the bisphenol (B), and the dicarboxylic acid (C),
the biphenol (A) has formula (1): 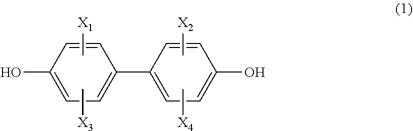
where X₁ through X₄ each independently represent a hydrogen atom, a halogen atom, or an alkyl group having 1 to 4 carbon atom(s) and may be identical to or different from each other,
the bisphenol (B) has formula (2): 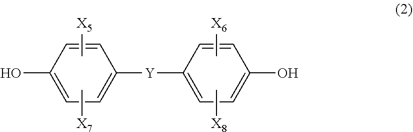
where X₅ through X₈ each independently represent a hydrogen atom, a halogen atom, or an alkyl group having 1 to 4 carbon atom(s) and may be identical to or different from each other; and Y represents a methylene group, an isopropylidene group, a cyclic alkylidene group, an aryl-substituted alkylidene group, an arylenedialkylidene group, —S—, —O—, a carbonyl group, or —SO₂—, and
the dicarboxylic acid (C) has formula (3):
HOOC—R₁—COOH (3)
where R₁ represents a divalent linear substituent which has 2 to 18 atoms in a main chain thereof and which optionally contains a branch.

2. The resin composition of claim 1, wherein the engineering resin is a polycarbonate resin.

3. The resin composition of claim 1, wherein the flowability enhancing agent has a number average molecular weight of 2000 to 30000.

4. The resin composition of claim 1, wherein R₁ in the formula (3) is a linear saturated aliphatic hydrocarbon chain.

5. The resin composition of claim 1, wherein
not less than 60% of terminals of the flowability enhancing agent are sealed with a monofunctional low molecular weight compound.

6. The resin composition of claim 1, wherein the engineering resin is included in an amount of 40% by mass to 90% by mass, the flowability enhancing agent is included in an amount of 1% by mass to 20% by mass, and the graft copolymer is included in an amount of 10% by mass to 60% by mass, with respect to 100% by mass of a total amount of the engineering resin, the flowability enhancing agent, and the graft copolymer.

7. A molded article obtained by a process including molding a resin composition of claim 1.

8. A plated molded product obtained by a process including plating the molded article of claim 7.

9. The resin composition of claim 1, wherein the monomer mixture comprises 10 mol % to 40 mol % of the biphenol (A), 10 mol % to 50 mol % of the bisphenol (B), and 45 mol % to 55 mol % of the dicarboxylic acid (C), with respect to 100 mol % of the total amount of the biphenol (A), the bisphenol (B), and the dicarboxylic acid (C).

10. The resin composition of claim 1, wherein the monomer mixture comprises 20 mol % to 30 mol % of the biphenol (A), 20 mol % to 30 mol % of the bisphenol (B), and 45 mol % to 55 mol % of the dicarboxylic acid (C), with respect to 100 mol % of the total amount of the biphenol (A), the bisphenol (B), and the dicarboxylic acid (C).

11. The resin composition of claim 1, wherein a molar ratio of the biphenol (A) to the bisphenol (B) in the monomer mixture is 1/9 to 9/1.

12. The resin composition of claim 1, wherein the bisphenol (B) in the monomer mixture comprises 2,2-bis(4-hydroxyphenyl)propane.

13. The resin composition of claim 1, wherein the engineering resin comprises at least one selected from the group consisting of a polycarbonate resin, polyester, polyphenylene ether, syndiotactic polystyrene, polyamide, polyarylate, polyphenylene sulfide, polyether ketone, polyether ether ketone, polysulfone, polyether sulfone, polyamide imide, polyether imide, and polyacetal.

14. The resin composition of claim 5, wherein the monofunctional low molecular weight compound comprises at least one selected from the group consisting of a monovalent phenol, a monoamine having 1 to 20 carbon atom(s), an aliphatic monocarboxylic acid, a carbodiimide, an epoxy, and an oxazoline.

15. The resin composition of claim 1, wherein R₁ in the formula (3) is —(CH₂)₈—, —(CH₂)₁₀—, or —(CH₂)₁₂—.

16. The resin composition of claim 1, wherein R₁ in the formula (3) is —(CH₂)₈—.

17. The resin composition of claim 1, wherein the bisphenol (B) in the monomer mixture comprises 2,2-bis(4-hydroxyphenyl)propane, and R₁ in the formula (3) is —(CH₂)₈—.

18. The resin composition of claim 1, wherein the bisphenol (B) in the monomer mixture comprises at least one selected from the group consisting of a bis(hydroxyaryl)alkane, a bis(hydroxyaryl)arylalkane, a bis(hydroxyaryl)cycloalkane, a dihydroxyarylether, a dihydroxydiarylsulfide, a dihydroxydiarylsulfoxide, a dihydroxydiarylsulfone, and a dihydroxydiphenyl.

19. The resin composition of claim 9, wherein the bisphenol (B) in the monomer mixture comprises at least one selected from the group consisting of a bis(hydroxyaryl)alkane, a bis(hydroxyaryl)arylalkane, a bis(hydroxyaryl)cycloalkane, a dihydroxyarylether, a dihydroxydiarylsulfide, a dihydroxydiarylsulfoxide, a dihydroxydiarylsulfone, and a dihydroxydiphenyl, and R₁ in the formula (3) is —(CH₂)₈—, —(CH₂)₁₀—, or —(CH₂)₁₂—.

20. The resin composition of claim 10, wherein the bisphenol (B) in the monomer mixture comprises at least one selected from the group consisting of a bis(hydroxyaryl)alkane, a bis(hydroxyaryl)arylalkane, a bis(hydroxyaryl)cycloalkane, a dihydroxyarylether, a dihydroxydiarylsulfide, a dihydroxydiarylsulfoxide, a dihydroxydiarylsulfone, and a dihydroxydiphenyl, and R₁ in the formula (3) is —(CH₂)₈—, —(CH₂)₁₀—, or —(CH₂)₁₂—.
